(19) United States
(12) Patent Application Publication
(10) Pub. No.: US 2006/0152191 A1
(43) Pub. Date: Jul. 13, 2006

(54) Apparatus for charging a secondary battery of a digital image processing apparatus with a charger for a cellular phone, and a digital image processing apparatus using the same

(75) Inventors: Yoo-shin Lee, Seoul (KR); Kun-sop Kim, Yongin-si (KR); Jae-hyun Cho, Seoul (KR); Won-kyu Jang, Seoul (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 11/152,407

(22) Filed: Jun. 14, 2005

(30) Foreign Application Priority Data
Jan. 12, 2005 (KR) 10-2005-0002935

(51) Int. Cl. H02J 7/00

(52) U.S. Cl. 320/106

(57) ABSTRACT

Provided are an apparatus for charging a secondary battery in a digital image processing apparatus using a charger for a cellular phone and a digital image processing apparatus using the apparatus. The apparatus comprises: a battery connection part connected to ports of a battery in the digital image processing apparatus; a charger connection part connected to a connector of the charger for the cellular phone; and a battery identification signal generator connected between the battery connection part and the charger connection part and connecting a resistance of a set value to a battery identification pin of the charger for the cellular phone if a secondary battery is connected to the charger connection part or not connecting the resistance to the batter identification pin of the charger for the cellular phone if a primary battery is connected to the charger connection part.

### CROSS-REFERENCE TO RELATED PATENT APPLICATION

This application claims the benefit of Korean Patent Application No. 10-2005-0002935, filed on Jan. 12, 2005, in the Korean Intellectual Property Office, the disclosure of which is incorporated herein in its entirety by reference.

### BACKGROUND OF THE INVENTION

1. Field of the Invention

The present invention relates to an apparatus for charging a secondary battery of a digital image processing apparatus, and more particularly, to an apparatus for charging a secondary battery of a digital image processing apparatus using a standardized charger for a cellular phone.

2. Description of the Related Art

Chargers for charging secondary batteries used in digital image processing apparatuses, for example, digital cameras, are known. Such chargers are manufactured and supplied by digital camera manufacturing companies according to their independent standards and thus are generally not compatible with digital cameras made by another manufacturing company. Also, cellular phones that are powered by secondary batteries have chargers that are not compatible with cameras. Thus, the chargers for the cellular phones and the chargers for the digital cameras are all needed. In view of the foregoing, an apparatus that facilitates charging of a secondary battery in a digital image processing apparatus and in a cellular phone would be welcomed.

### SUMMARY OF THE INVENTION

The present invention provides an apparatus for charging a secondary battery in a digital image processing apparatus using a charger for a cellular phone without an independent charger and a digital image processing apparatus using the same.

According to an aspect of the present invention, there is provided an apparatus for charging a secondary battery in a digital image processing apparatus using a cellular phone charger that includes a connector having a battery identification pin that identifies a type of the secondary battery and a power supply pin that supplies a charge power to the secondary battery, wherein the apparatus comprises: a battery connection part that mates with ports of a battery installed in the digital image processing apparatus; a charger connection part that mates with a connector of the charger for the cellular phone; and a battery identification signal generator connected between the battery connection part and the charger connection part. The battery identification signal generator connects a resistance of a set value to the battery identification pin of the cellular phone charger if a secondary battery is mated with the battery connection part, whereas the battery identification signal generator does not connect the resistance to the battery identification pin of the charger for the cellular phone if a primary battery is mated with the battery connection part.

The battery connection part includes an identification electrode connector that mates with an identification electrode of the secondary battery. The battery identification signal generator includes a switch that is opened and closed depending on whether the identification electrode connector is mated with the identification electrode of the secondary battery. Here, the switch determines the connection of the resistance to the battery identification pin.

According to another aspect of the present invention, a digital image processing apparatus adopting the apparatus is provided.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view illustrating the front of a digital camera as a digital image processing apparatus according to an embodiment of the present invention;

FIG. 2 is a rear view of the digital camera shown in FIG. 1;

FIG. 3 is a block diagram of the digital camera shown in FIG. 1;

FIG. 4 is a circuit diagram of an apparatus for charging a secondary battery in a digital image processing apparatus according to an embodiment of the present invention;

FIG. 5 is a view illustrating a diagrammatic view of charging a secondary battery using the apparatus shown in FIG. 4;

FIG. 6 is a view illustrating a diagrammatic view of charging a secondary battery using a secondary battery charger corresponding to a cellular phone charger according to the TTA standards;

FIG. 7 is a view illustrating a primary battery connected to the apparatus shown in FIG. 4; and

FIG. 8 is a flowchart of a method of charging a secondary battery in a digital image processing apparatus according to an embodiment of the present invention.

### DETAILED DESCRIPTION OF THE INVENTION

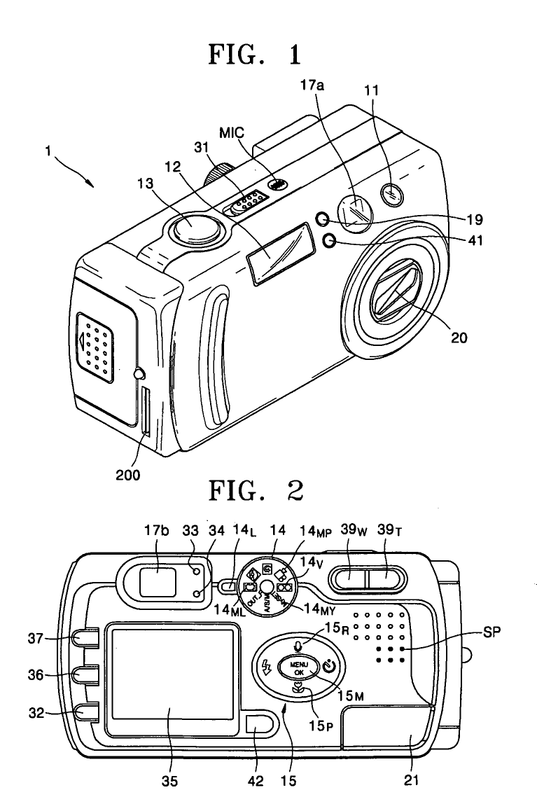

Referring to FIG. 1, a digital camera 1 as a digital image processing apparatus according to the present invention includes a microphone (MIC), a self-timer lamp 11, a flash 12, a shutter release button 13, a view finder 17a, a flashlight sensor 19, a power switch 31, a lens unit 20, and a remote receiver 41. The digital camera 1 also includes a charger connection port 200 that is directly related to the characters of the present invention and will be described later.

In a case of a self-timer mode, the self-timer lamp 11 operates for a set period of time, i.e., from a point of time in which the shutter-release button 13 is pressed to a point of time in which an image starts to be captured. When the flash 12 operates, the flashlight sensor 19 senses a light intensity of the flash 12 and inputs the light intensity into a digital camera processor (DCP) 507 shown in FIG. 3 via a microcontroller 512 shown in FIG. 3.

The remote receiver 41 receives an infrared photographing command from a remote controller (not shown) and inputs the infrared photographing command into the DCP 507 via the microcontroller 512.

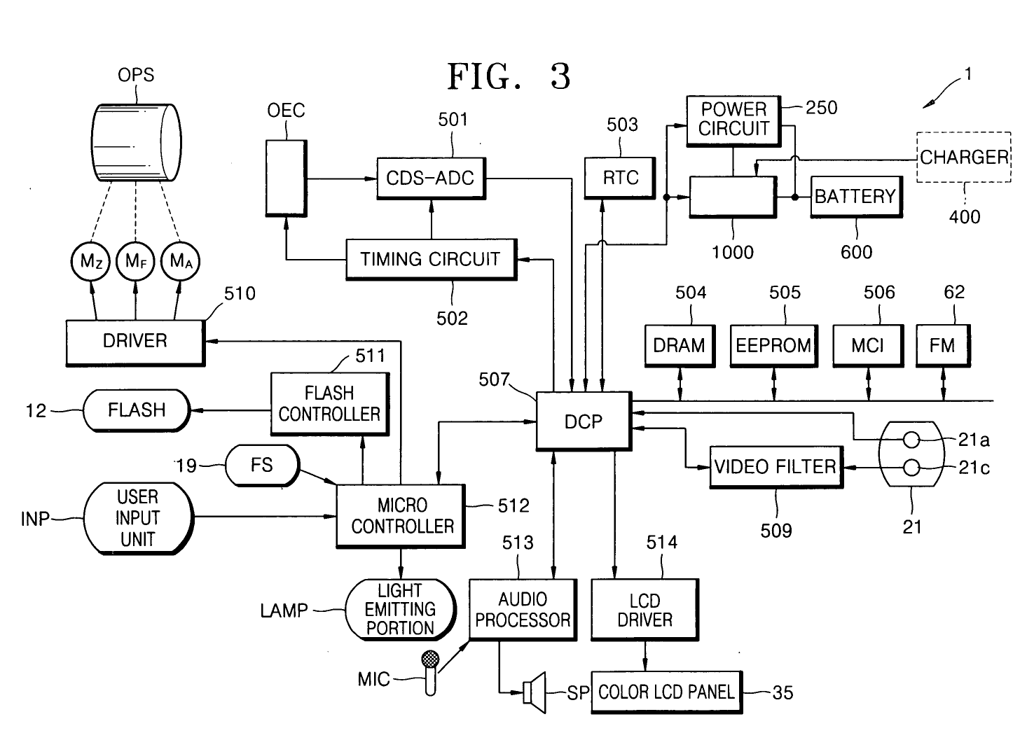

The shutter-release button 13 has a two-step structure. In other words, when a user manipulates a wide angle-zoom button 39_{W} (FIG. 2) and a telephoto-zoom button 39_{T} (FIG. 2) and then presses the shutter-release button 13 to a first step, a signal S1 that is output from the shutter-release button 13 is on. When the user presses the shutter-release button 13 to a second step, a signal S2 that is output from the shutter-release button 13 is on.

Referring to FIG. 2, the digital camera 1 also includes a mode dial 14, a function button 15, a manual focusing and/or delete button 36, a manual adjustment and/or play button 37, a play mode button 42, a speaker SP, a monitor button 32, a auto-focus lamp 33, a view finder 17b, a flash standby lamp 34, a color liquid crystal display (LCD) panel 35, the wide angle-zoom button 39_{W}, the telephoto-zoom button 39_{T}, and an external interface 21.

The mode dial 14 is used by a user to select and set camera operation modes, for example, a synthesization mode 14_{ML}, a program mode, a portrait mode, a night view mode, a manual mode, a moving picture mode 14_{MP}, a user set mode 14_{MY}, and a voice recording mode 14_{V}.

Here, the synthesization mode 14_{ML} refers to an operation mode in which an input image and an auxiliary image are synthesized. The user set mode 14_{MY} refers to an operation mode in which the user sets information necessary for a still image or moving picture mode. The voice recording mode 14_{V} refers to an operation mode in which sound, for example, only voice of the user is simply recorded.

The function button 15 is used by the user to perform specific functions of the digital camera 1 and is also used as a direction-moving button of an activated cursor that is displayed on a menu screen of the color LCD panel 35.

For example, the user presses a macro and/or down-shift button 15_{P} in the still image or moving picture mode to set a near auto focusing. When the user presses a menu and/or selection-confirm button 15_{M} to display a menu for setting conditions of an operation mode, the user presses the macro and/down-shift button 15_{P} to shift the activated cursor downward.

When the user presses a voice-memo and/or up-shift button 15_{R}, recording may be performed for 10 seconds after a subsequent photographing operation. Also, when the user presses the menu and/selection-confirm button 15_{M} to display a menu for setting conditions of an operation mode, the user presses the voice-memo and/or up-shift button 15_{R} to shift the activated cursor up. When the activated cursor is positioned in a selection item, the user may press the menu and/selection-confirm button 15_{M} so as to perform an operation corresponding to the selection item.

The manual-focusing and/or delete button 36 is used by the user to perform manual focusing or deletion in a photographing mode. The manual-adjustment and/or play button 37 is used to manually adjust specific conditions and perform a pause or play function in a play mode. A play mode button 42 is used to change a current mode into the play mode or a preview mode.

A monitor button 32 is used by used to control an operation of the color LCD panel 35. For example, if the user first presses the monitor button 32 in the photographing mode, an image of a subject and photographing information as to the subject are displayed on the color LCD panel 35. If the user secondly presses the monitor button 32, power applied to the color LCD panel 35 is interrupted. If the user first presses the monitor button 32 during a play of an image file in the play mode, photographing information as to the image file is displayed on the color LCD panel 35. If the user secondly presses the monitor button 32, only the image file is displayed on the color LCD panel 35.

The auto-focus lamp 33 operates when a focus is adjusted. The flash standby lamp 34 operates when the flash 12 shown in FIG. 1 is in a standby mode. A mode indication lamp 14_{L} indicates a selection mode of the mode dial 14.

FIG. 3 is a block diagram of the digital camera 1 shown in FIG. 1. The whole structure and operation of the digital camera 1 shown in FIG. 1 will now be described with reference to FIGS. 1 through 3.

An optical system (OPS) includes a lens unit and a filter unit and optically processes light from a subject The lens unit of the OPS includes a zoom lens, a focus lens, and a compensation lens.

If the user presses the wide angle-zoom button 39_{W} or the telephoto-zoom button 39_{T} of a user input unit INP, a signal corresponding to the press of the user is input into the microcontroller 512. Thus, the microcontroller 512 controls a driver 510 to drive a zoom motor M_{Z} so as to shift the zoom lens. In other words, if the wide angle-zoom button 39_{W} is pressed, a focus length of the zoom lens is shortened. Thus, a picture angle is widened. If the telephoto-zoom button 39_{T} is pressed, the focus length of the zoom lens is lengthened. Thus, the picture angle is narrowed. Here, when a position of the zoom lens is set, a position of the focus lens is adjusted. Therefore, the picture angle is hardly affected by the position of the focus lens.

A main controller in the DCP 507 controls the driver 510 via the microcontroller 512 to drive a focus motor M_{F} in an auto-focusing mode. As a result, the focus lens is shifted, and the position of the focus lens in which high frequency components of an image signal are increased, for example, a number of drive steps of the focus motor M_{F} is set.

The compensation lens of the lens unit of the OPS compensates for a whole refraction index and thus is not additionally driven. Reference character M_{A} refers to a motor for driving an aperture (not shown).

In the filter unit (not shown) of the OPS, an optical low pass filter (OLPF) removes optical noise of a high frequency component. An infrared cut filter (IRF) cuts an infrared component of incident light.

An optoelectric converter (OEC) of a charge coupled device (CCD) or a complementary metal-oxide-semiconductor (CMOS) converts light output from the OPS into an electric analog signal. Here, the DCP 507 controls a timing circuit 502 to control operations of the OEC and a correlation double sampler and analog-to-digital converter (CDS-ADC) 501. The CDS-ADC 501 processes the electric analog signal output from the OEC, removes high frequency noise from the electric analog signal, adjusts amplitude of the electric analog signal, and converts the electric analog signal into a digital signal.

A real-time clock (RTC) 503 offers time information to the DCP 507. The DCP 507 processes the digital signal output from the CDS-ADC 501 to generate a digital image signal which is split into luminance and chromaticity signals.

A lamp LAMP is driven by the microcontroller 512 according to control signals output from the DCP 507 including the main controller and includes the self-timer lamp 11, the auto-focus lamp 33, the mode indication lamp 14_{L}, and the flash standby lamp 34. The user input unit INP includes the shutter-release button 13, the mode dial 14, the function button 15, the monitor button 32, the manual-focusing and/or delete button 36, the manual-adjustment and/or play button 37, the wide angle-zoom button 39_{W}, and the telephoto-zoom button 39_{T}.

A dynamic random access memory (DRAM) 504 temporally stores the digital image signal output from the DCP 507. An electrically erasable and programmable read only memory (EEPROM) 505 stores an algorithm necessary for operating the DCP 507. A memory card of a user is attached to and/or detached from a memory card interface (MCI) 506. A flash memory (FM) 62 stores set data necessary for operating the DCP 507. The set data includes data on auxiliary images for synthetic photographing. The MCI 506 attaches the memory card of the user thereto and/or detaches the memory card of the user therefrom.

The digital image signal output from the DCP 507 is input into an LCD driver 514 so as to display an image on the color LCD panel 35.

The digital image signal output from the DCP 507 may be transmitted via a universal serial bus (USB) connector 21a in serial and transmitted as a video signal via a video filter 509 and a video output unit 21c.

An audio processor 513 outputs a voice signal output from the MIC to the DCP 507 or the SP and an audio signal output from the DCP 507 to the SP.

The microcontroller 512 controls the operation of the flash controller 511 according to a signal output from the flashlight sensor 19 to drive the flash 12.

The digital camera 1 shown in FIG. 3 includes a charging module 1000, a battery 600 and a power circuit 250. As shown, the charging module 1000 is connected to the battery 600 and the power circuit 250, which supplies power to each circuit of the digital camera 1 from the battery 600 and/or from an external charger 400. The battery 600 may be a primary (i.e., disposable) battery or a secondary (i.e., rechargeable) battery. The battery 600 may be of various sizes, capacities and types, including, for example, lithium-ion. The charging module 1000 of the present invention facilitates charging of a secondary battery that is installed in a camera by using either a camera charger or a cellular phone charger instead of the camera charger that is supplied by camera manufacturing companies with the camera and according to their independent standards.

The cellular phone charger is a charger of which a connecter is inserted into an input and output port of a cellular phone to charge a cellular phone battery. Cellular phone manufacturing companies manufacture cellular phone chargers having connectors with different numbers of pins (e.g., 18-pin or 24-pin connectors). As is known, arrangements and use purposes of the pins of such cellular phone chargers differ from one manufacturer to another manufacturer. In other words, the connectors are made according to additional standards and thus are not compatible with one another. Thus, if a cellular phone is replaced with new one, a charger of the cellular phone must also be replaced with new one. Therefore, to secure the compatibility of chargers, the Telecommunication Technology Association (TTA), which is an information telecommunication (IT)-related organization (i.e., Korea Information and Communication Association) in Korea, enacted a 24-pin cellular phone charger standard. Cellular phone chargers that are manufactured according to the TTA 24-pin standard are used in Korea and other countries. A 24-pin charger according to the TTA standards includes a connector having 24 pins that are arranged and have use purposes according to the TTA standards and determine charge currents that are appropriate for charging various types and capacities of batteries.

Table 1 below shows pin numbers for 24-pin cellular phone chargers according to the TTA standards, signal names from cellular phone input and output ports related to the pins, and functions of the pins.

TABLE 1

| Pin Number | Signal Name | Pin Function |
|---|---|---|
| 1 | Battery ID | 27 KΩ: 450 mA |
| | | 4.7 KΩ: 750 mA |
| | | 1.5 KΩ: 900 mA |
| | | *Allowance of Charge Current: ±50 mA |
| | | *Charge only when an ID resistance |
| | | value is recognized as one of the above |
| | | values. |
| | | *When 900 mA is not output, 1.5 KΩ is |
| | | recognized but 700 mA is output. |
| 21, 22 | PPOWER | Supply power to cellular phone with |
| | (+4.2 V)/SWB+ | external charging circuit. |
| 4, 5 | POWER | Supply power to cellular phone with |
| | (+5˜5.5 V | internal charging circuit. |
| 12, 19 | POWER | Ground power. |
| | GROUND | |

As shown in Table 1, pin 1 of the 24-pin charger according to the TTA standards is called a battery ID pin and serves to determine a type and capacity of a secondary battery that is installed in a cellular phone so that the charger can provide the secondary battery with an appropriate charge current. Secondary batteries that are configured to be installed in a cellular phone typically include an anode and a cathode, which supply power to the cellular phone, and an identification electrode. Also, an internal resistance is connected between the identification electrode and the anode to facilitate identification of the type and capacity of the secondary battery to thereby ensure proper charging. A charger reads the internal resistance to determine the proper charge current to provide to the secondary battery. As shown in Table 1, when the internal resistance is 27KΩ, the secondary battery is charged with a charge current of 450 mA. When the internal resistance is 4.7 KΩ, the secondary battery is charged with a charge current of 750 mA. When the internal resistance is 1.5 KΩ, the secondary battery is charged with a charge current of 900 mA. Pins 21 and 22 are used to supply power to a cellular phone with an external charging circuit. Pins 4 and 5 are used to supply power to a cellular phone with an internal charging circuit. Pins 12 and 19 are used to ground power.

In general, a second battery is used in a cellular phone. However, both of primary and secondary batteries may be used in a camera such as the digital camera 1 (FIGS. 1 and 2). A secondary battery may perform charging and discharging, but a primary battery exhausts its lifespan due to one-time discharging. Thus, if an individual were to attempt charging of a primary battery that is installed in a camera, the primary battery may leak a charge current in its cell, which may cause the camera to be damaged or broken down. Therefore, it would be beneficial for the camera 1 to communicate the type of battery that is installed therein to a charger to thereby prevent a primary battery from being supplied with a charge current.

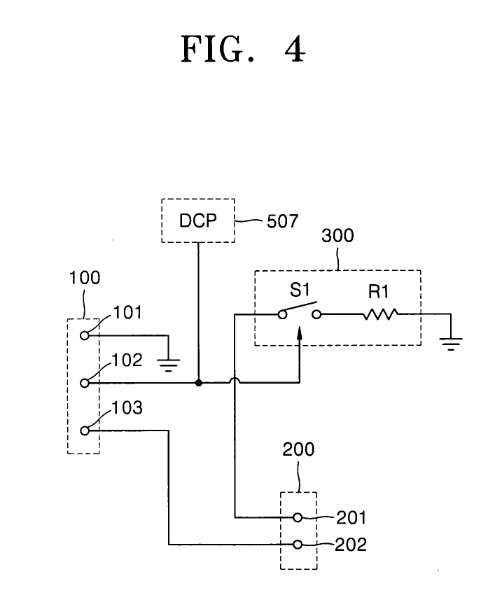

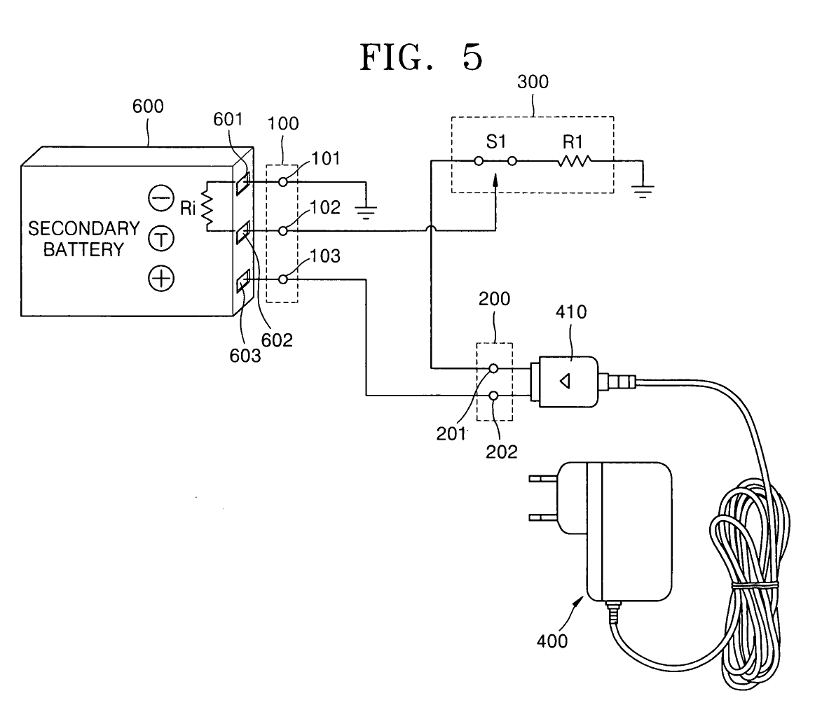

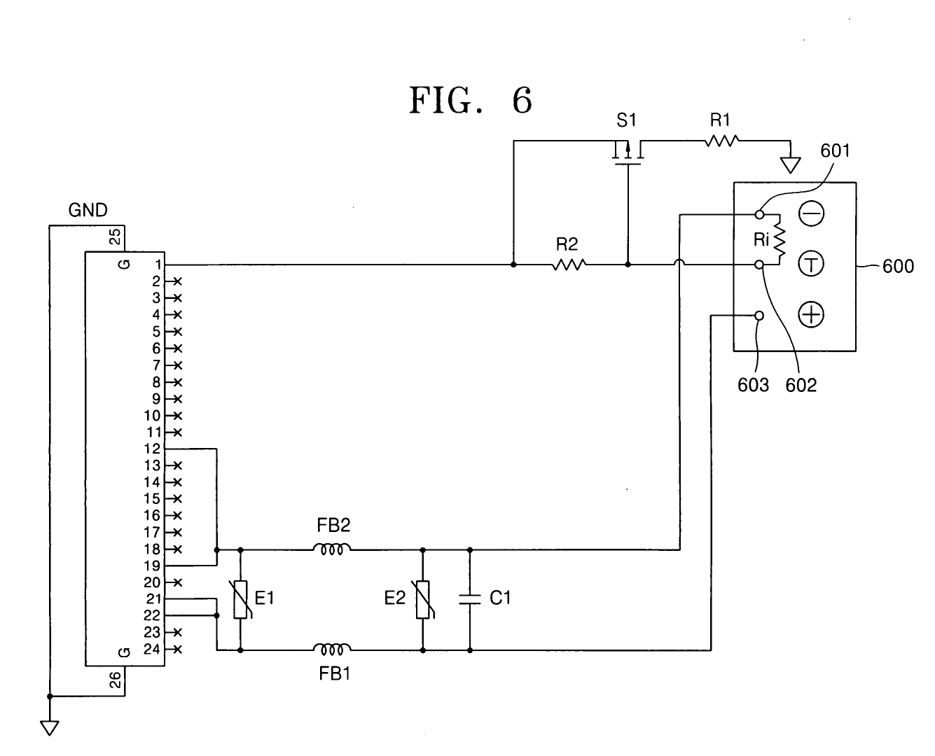

As shown in FIGS. 5 and 6, the secondary battery 600 that is used for a camera includes an identification electrode 602 (similar to a secondary battery that is used for a cellular phone) and an internal resistance Ri that is connected between the identification electrode 602 and an anode 601. However, a value of the internal resistance Ri is not standardized as with the secondary battery used for the cellular phone. For example, one example secondary battery that is used for a digital camera is UCA-3 available from SAMSUNG TECHWIN CO., LTD. This example secondary battery includes a thermistor of 10 KΩ instead of a resistance. The thermistor protects cells of the secondary battery from overheating, for example, during charging. As is known, the resistance value of a thermistor varies with variations in the temperature in terms of its characteristic. Thus, depending on the temperature a resistance value of the thermistor may be determined as not being suitable for a cellular phone charger (i.e., the resistance of the thermistor may be different from the values shown in Table 1). Thus, such an example secondary battery may not be stably charged. An apparatus for charging a secondary battery in a digital image processing apparatus of the present invention constituted in consideration of the above-described points is shown in FIG. 4.

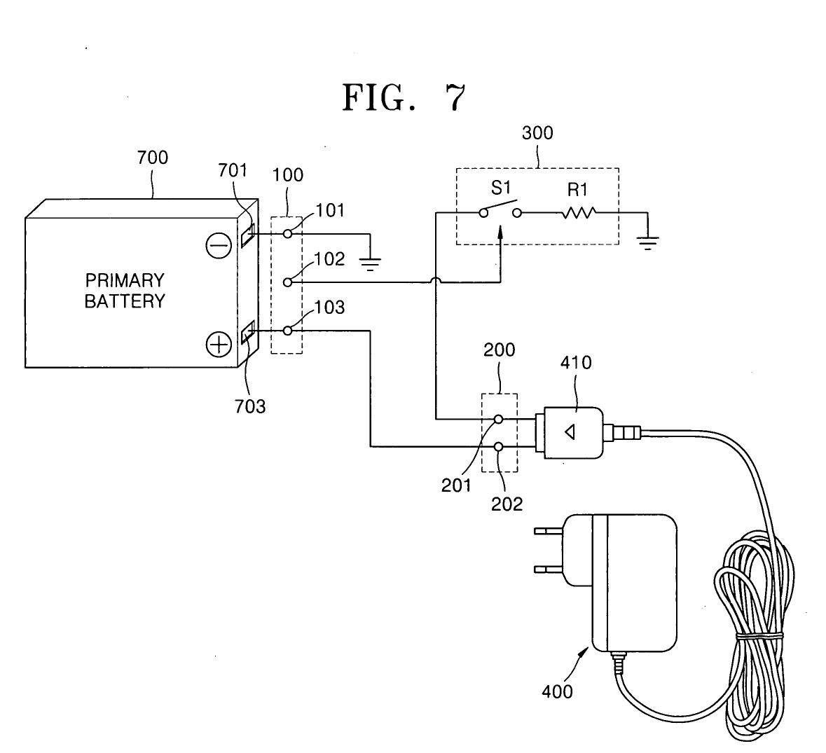

FIG. 5 is a view illustrating a somewhat diagrammatic view of charging a secondary battery by using an apparatus for charging the secondary battery in the digital image processing apparatus shown in FIG. 4. FIG. 6 is another somewhat diagrammatic view illustrating charging a secondary battery in a digital image processing apparatus by using a cellular phone charger according to the TTA standards. FIG. 7 is yet another view illustrating a primary battery connected to the apparatus shown in FIG. 4.

If the digital image processing apparatus of the present invention is a digital camera, the apparatus for charging the secondary battery is denoted by reference numeral 1000 shown in FIG. 3. Resistors E1 and E2, coils FB1 and FB2, and a capacitor C1 constitute an auxiliary circuit stabilizing a direct current (DC) power voltage—that is a DC/DC converter or the like that maintains a constant DC voltage.

Referring to FIGS. 4 through 7, the apparatus 1000 for charging the secondary battery according to the present invention includes a battery connection part 100, a charger connection part 200, and a battery identification signal generator 300. The battery connection part 100 is connected to ports 601, 602, and 603 of primary battery 600 or ports 701 and 703 of the secondary battery 700 that is installed in the digital image processing apparatus. The battery connection part 100 includes an anode connector 101 that mates with an anode 601 or 701 of the secondary or primary battery 600 or 700, respectively. The battery connection part 100 also includes an identification electrode connector 102 that mates with the identification electrode 602 of the secondary battery 600, and a cathode connector 103 that mates with a cathode 603 of the secondary battery 600 or a cathode 703 of the primary battery 700. As shown in FIG. 7, in a case where the digital camera 1 includes the primary battery 700 that does not have an identification electrode, the identification electrode connector 102 is not mated with the battery 700.

The charger connection part 200 is configured to receive a connector 410 of an external (e.g., cellular phone) charger 400. The charger connection part 200 includes a battery identification pin connector 201 that is connected to a battery identification pin (i.e., pin 1 shown in FIG. 6) of the connector 410 of the external charger 400 and a power connector 202 that is connected to power connectors (i.e., pins 21 and 22 shown in FIG. 6) of the connector 410 of the external charger 400.

Therefore, in a case where a 24-pin cellular phone charger according to the TTA standards is used for charging a battery that is installed in a digital photographing apparatus, the identification electrode connector 102 is mated with the pin 1 of the cellular phone charger (e.g., external charger 400) and the power connector 202 is mated with the pins 21 and 22 of the cellular phone charger.

The battery identification signal generator 300 is connected between the battery connection part 100 and the charger connection part 200. Thus, if the secondary battery 600 is engaged with the battery connection part 100, the resistance R1, which has a set value, is connected to the battery identification pin of the external charger 400 via battery identification pin connector 201. If the primary battery 700 is engaged with the battery connection part 100, the resistance R1 is not connected to the battery identification pin. In the case of the 24-pin cellular phone charger according to the TTA standards as shown in FIG. 6, the pin 1 is a battery identification pin.

The battery identification signal generator 300 includes a switch S1 that is opened and closed depending on whether the identification electrode connector 102 is engaged with the identification electrode 602 of the secondary battery 600. Thus, the switch S1 determines the connection of the resistance R1 to the battery identification pin.

As illustrated in FIG. 6, one example switch S1 is a p-channel field effect transistor (p-FET), but the switch S1 may be other types of transistors and switches that are known in the art. A potential of the identification electrode 602 of the secondary battery 600 that is used for the digital camera is on a “low” level. The digital camera determines as to whether the primary or secondary battery is used therefore to offer information necessary for setting the lowest use voltage suitable for the primary or secondary battery. Further, as shown in FIG. 4, the identification electrode connector 102 is connected to the DCP 507 (see also FIG. 3) to facilitate changing (i.e., updating) a battery-shaped OSD on a screen 35 according to the usage/charging time.

The potential of the identification electrode 602 is on the “low” level. Thus, when a signal on a “low” level is provided to the apparatus 1000, the switch S1 is closed so that the resistance R1 is connected to the battery identification pin of the connector 410 of the external charger 400 via the battery identification pin connector 201.

As shown in FIG. 7, when a primary battery 700 is installed in the digital camera, the identification electrode connector 102 does not output a signal on the “low” level. Thus, the switch S1 is opened, and thus the resistance R1 is not connected to the battery identification pin. In this case, the external charger 400 determines that there is no resistance connected to a battery identification pin, meaning that there is no suitable battery to be charged and not to supply a charger current.

In a case where the external charger 400 is a cellular phone charger used during a trip (i.e., a travel charger), a value of the resistance R1 may a value to supply a set charge current. The resistance R1 shown in FIGS. 5 through 7 is 4.7 KΩ. As shown in Table 1, 4.7 KΩ) is one of values of a standard internal resistance according to the type of a cellular phone battery. For example, a capacity of the secondary battery 600 of the digital camera 1 is 1000 mAh or more. Thus, a charge current of 750 mA is applied to the secondary battery 600. The resistance R1 may be a value of another standard internal resistance.

The external charger 400 may be a 24-pin charger according to the TTA standards. The external charger 400 may also be a battery charger that is provided with the camera 1 or a cellular phone charger which includes a battery identification pin and determines an internal resistance of a battery to supply a charge current corresponding to a predetermined internal resistance value to the battery.

To charge a cellular phone, the connector of the cellular phone charger (e.g. external charger 400) may be directly connected to an input and output port of the cellular phone. Alternatively, the cellular phone may be mounted on a cradle to connect the connector of the cellular phone charger to a connection part of the cradle so as to connect the cellular phone charger to the cellular phone via the cradle. In the present embodiment, the charger connection part 200 may be directly connected to the connector 410 of the external (e.g., cellular phone) charger 400. Also, the charger connection part 200 may be connected to the connector 410 of the external (e.g., cellular phone) charger 400 via connectors connected to the charger connection part 200 and a cradle including connectors connected to the connector 410 of the external (e.g., cellular phone) charger 400.

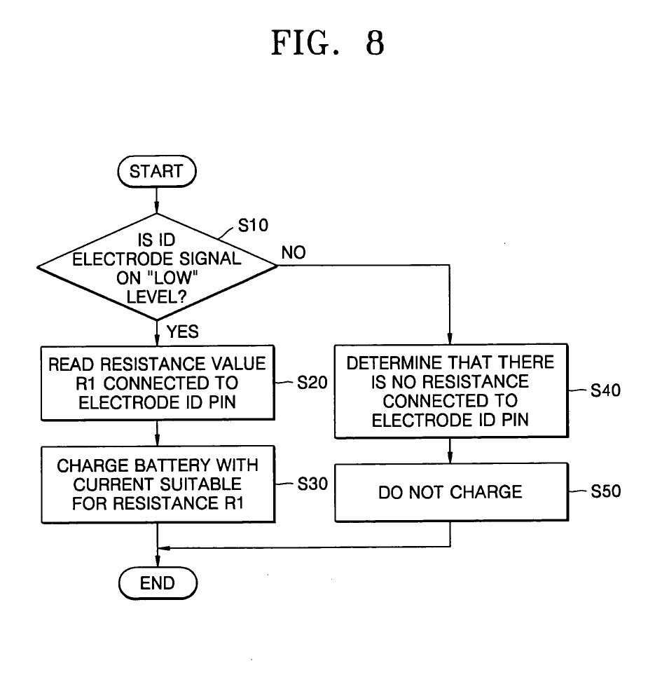

FIG. 8 is a flowchart illustrating an example process of charging a secondary battery according to an embodiment of the present invention. An operation of the apparatus 1000 for charging a secondary battery will now be described with reference to FIGS. 5, 7, and 8.

When the external (e.g., cellular phone) charger 400 is connected to the charger connection part 200 of the digital camera 1 shown in FIG. 3 as the digital image processing apparatus, in operation S10, a determination is made as to whether an identification electrode signal “low” is sensed by the identification electrode connector 102 of the battery connection part 100. When a secondary battery is mounted and thus the electrode identification signal generator 300 senses the identification electrode signal “low,” the switch S1 is closed. Thus, in operation S20, the resistance R1 is read via the battery identification pin of the external charger 400. In operation S30, the secondary battery is charged with a current suitable for the resistance R1 according to an operation of an internal switch of the external charger 400. If a primary battery is mounted and thus the identification electrode signal “Low” is not output, in operation S40, the switch S1 is opened and thus the external charger 400 determines that there is no resistance connected to a battery identification pin. As a result, the primary battery is not charged.

A digital camera has been described in the above embodiment. However, it will be obvious that the present invention may be applied to a digital image processing apparatus using primary and/or secondary batteries to supply power.

As described above, in an apparatus for charging a secondary battery in a digital image processing apparatus using a charger for a cellular phone and a digital image processing apparatus using the same, according to the present invention, a standard cellular phone charger can be used without an additional charger. Thus, in a case where the digital image processing apparatus includes the secondary battery, the standard cellular phone charger can charge the secondary battery. In a case where the digital image processing apparatus includes a primary battery, the standard cellular phone charger does not charge the primary battery.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A charging module for a digital image processing apparatus, the charging module being connected with a battery and accepting a connector of an external charger for charging the battery, the charging module comprising:
a battery connection part that mates with contacts of the battery;
a charger connection part that mates with the connector of the external charger; and
a battery identification signal generator connected between the battery connection part and the charger connection part, wherein the battery identification signal generator selectively connects a resistance having a set value to a battery identification pin of the external charger depending on a characteristic of the battery.

2. The charging module of claim 1 wherein the battery connection part comprises an identification electrode connector that mates with an identification electrode of the battery for determining the characteristic and communicating said characteristic to the battery identification signal generator.

3. The charging module of claim 2 wherein the battery identification signal generator comprises a switch that is actuated to connect the resistance with the charger connection part depending on whether the identification electrode connector is connected to the identification electrode.

4. The charging module of claim 3 wherein the switch comprises a transistor.

5. The charging module of claim 4 wherein the transistor comprises a p-channel field effect transistor.

6. The charging module of claim 1, wherein the charger connection part comprises:
a battery identification pin port that engages with the battery identification pin of the external charger; and
a power port that engages with a power connector of the connector of the external charger.

7. The charging module of claim 3, wherein the charger connection part comprises:
a battery identification pin port that engages with the battery identification pin of the external charger and is connected with one end of the switch for linking the resistance to the external charger; and
a power port that engages with a power connector of the connector of the external charger for linking the power connector with the battery.

8. The charging module of claim 1, wherein the charger connection part is configured to receive at least one of a connector of a cellular phone charger and a connector of a digital camera charger.

9. The charging module of claim 8 wherein the cellular phone charger is configured according to a 24-pin standard.

10. The charging module of claim 1 wherein the battery identification signal generator determines an internal resistance value of the battery and compares said internal resistance value to predetermined resistance values of known batteries to prevent improper charging of the battery.

11. The charging module of claim 10 wherein the predetermined resistance values are selected from the group consisting of 27kΩ, 4.7kΩ and 1.5kΩ.

12. A digital camera apparatus comprising:
a digital camera processor for converting light that is reflected from a subject and received by an optical system to image data;
a color LCD screen connected with the digital camera processor for displaying an image of the subject relative to the image data and photographing information;
a battery for powering the digital camera processor and the color LCD screen; and
a charging module that engages with the battery and accepts a connector of an external charger that is configured to charge a cellular phone battery.

13. The digital camera apparatus of claim 12 wherein the charging module comprises:
a battery connection part that mates with contacts of the battery;
a charger connection part that mates with the connector of the external charger; and
a battery identification signal generator connected between the battery connection part and the charger connection part, wherein the battery identification signal generator selectively connects a resistance having a set value to a battery identification pin of the external charger depending on a characteristic of the battery.

14. The digital camera apparatus of claim 13 wherein the digital camera processor is connected with the battery identification signal generator for displaying battery-charging information on the color LCD screen when the connector of the external charger is engaged with the charger connection part.

15. The digital camera apparatus of claim 13 wherein the battery connection part comprises an identification electrode connector that mates with an identification electrode of the battery for determining the characteristic and communicating said characteristic to the battery identification signal generator.

16. The digital camera apparatus of claim 13 wherein the battery identification signal generator comprises a switch that is actuated to connect the resistance with the charger connection part depending on whether the identification electrode connector is connected to the identification electrode.

17. The digital camera apparatus of claim 16 wherein the switch comprises a p-channel field effect transistor.

18. The digital camera apparatus of claim 16, wherein the charger connection part comprises:
a battery identification pin port that engages with the battery identification pin of the external charger and is connected with one end of the switch for linking the resistance to the external charger; and
a power port that engages with a power connector of the connector of the external charger for linking the power connector with the battery.

19. The digital camera apparatus of claim 13 wherein the charger connection part comprises about 24 pins.

20. A charging module for a digital image processing apparatus, the charging module being connected with a battery and accepting a connector of an external charger that is configured to charge a cellular phone battery, the charging module comprising:
a battery connection part that mates with contacts of the battery;
a charger connection part that mates with the connector of the external charger; and
a battery identification signal generator connected between the battery connection part and the charger connection part, wherein the battery identification signal generator selectively connects a resistance having a set value to a battery identification pin of the external charger depending on a characteristic of the battery.
